(19) United States
(12) Patent Application Publication
(10) Pub. No.: US 2009/0141613 A1
(43) Pub. Date: Jun. 4, 2009

(54) HOLOGRAM APPARATUS

(75) Inventors: Shinji Mitsuya, Miyagi-ken (JP); Seiichi Ohgoshi, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 12/365,420

(22) Filed: Feb. 4, 2009

(30) Foreign Application Priority Data
Aug. 14, 2006 (JP) 2006-221122

(51) Int. Cl. G11B 7/00

(52) U.S. Cl. 369/103; G9B/7

(57) ABSTRACT

A light-shielding member having a pinhole filter is disposed at a boundary between reference light emitted from a light source and reproduction light output from a holographic recording medium. The reproduction light passes through a pinhole formed on the pinhole filter and enters a light-shielded space in which a photodetector member is disposed. The pinhole is disposed at a position of a beam waist BW at which the beam diameter is at a minimum. Therefore, the photodetector member is prevented from detecting light other than the reproduction light. The pinhole filter includes the transparent substrate as a base material, and therefore blocks dust from entering the light-shielded space.

### CLAIM OF PRIORITY

This application claims benefit of the Japanese Patent Application No. 2006-221122 filed on Aug. 14, 2006, which is hereby incorporated by reference.

### BACKGROUND OF THE INVENTION

1. Field of the Invention

The present invention relates to hologram apparatuses which read data recorded on a holographic recording medium, and more particularly, to a hologram apparatus capable of preventing stray light and dust from reaching a photodetector.

2. Description of the Related Art

Japanese Unexamined Patent Application Publication No. 2006-99925 discloses an invention relating to a hologram reproducing head. The hologram reproducing head includes a light source 3 which emits a laser beam toward a hologram 11 and a light receiving unit 4 which receives reproduction light from the hologram 11. The light source 3 and the light receiving unit 4 are accommodated in a box-shaped head body 1. A transparent plate 5 is placed so as to face the light source 3 and the light receiving unit 4. The transparent plate 5 includes a light-path changing hologram 5a for directing reference light emitted from the light source 3 toward the hologram 11 and a pin-hole filter 6a which allows only necessary reproduction light to pass therethrough toward the light receiving unit 4.

In the hologram reproducing head described in Japanese Unexamined Patent Application Publication No. 2006-99925, the light source 3 and the light receiving unit 4 are accommodated in the same box-shaped head body 1. Therefore, there is a possibility that light emitted from the light source 3 and other unnecessary light will be reflected in the head body 1 and received by the light receiving unit 4 as stray light. The stray light serves as a noise component for the light receiving unit 4, and therefore the hologram reproducing head easily causes read error.

### SUMMARY OF THE INVENTION

To solve the above-described problem, the present invention provides a hologram apparatus which prevents unnecessary stray light from reaching a photodetector member so that the photodetector member is not easily affected by a noise component, thereby providing increased reading accuracy.

According to an aspect of the present invention, a hologram apparatus includes a carriage arranged to face an optical recording medium, a light source mounted on the carriage and configured to emit reference light for reproducing information from the optical recording medium, and a photodetector member mounted on the carriage and configured to detect reproduction light emitted from the optical recording medium in response to receiving the reference light. The carriage has a light-shielded space which surrounds the photodetector member, the light-shielded space being surrounded by a plurality of wall surfaces of the carriage and a light-shielding member positioned between the optical recording medium and the photodetector member. The light-shielding member includes a pinhole filter positioned at a boundary between a light path of the reference light and a light path of the reproduction light, the pinhole filter allowing only the reproduction light to pass therethrough and guiding the reproduction light toward the photodetector member.

According to the present invention, the light path of the reference light and the light path of the reproduction light are separated from each other by the light-shielding member. Therefore, the photodetector member is prevented from detecting the reproduction light. As a result, the occurrence of read errors caused by the hologram apparatus can be reduced.

The pinhole filter may include, for example, a transparent substrate, a light-blocking film formed on at least one surface of the transparent substrate, and a pinhole formed by partially leaving an area where the light-blocking film is not formed on the transparent substrate so that the transparent substrate is partially exposed at the pinhole.

In this case, a function as the pinhole and a function of preventing dust from entering the light-shielded space can both be provided.

The pinhole is preferably disposed at a position corresponding to the beam waist at which a beam diameter of the reproduction light is at a minimum.

In such a case, the pinhole filter also blocks reproduction light other than the desired reproduction light. Therefore, the reading accuracy can be increased.

The above-described light-blocking film preferably includes a metal film.

In such a case, the metal film can be easily formed by, for example, sputtering or vapor deposition.

In the above-described structure, since the light-shielded space can be isolated from the outside, unnecessary light (for example, the reference light) other than the reproduction light can be reliably prevented from entering the light-shielded space. Thus, a hologram apparatus capable of reducing the occurrence of read errors can be obtained.

An antireflection film is preferably formed on one or both of the light-shielding member and the wall surfaces.

In such a case, light that enters the light-shielded space can be prevented from being reflected in the light-shielded space. Therefore, the occurrence of read errors caused by the hologram apparatus can be further reduced.

According to the present invention, unnecessary light other than the desired reproduction light to be detected by the photodetector member can be prevented from being detected. In addition, dust can be prevented from entering the light-shielded space in which the photodetector member is placed. Therefore, the occurrence of read errors caused by the hologram apparatus can be reduced.

### BRIEF DESCRIPTION OF THE DRAWINGS

FIG. 1 is a perspective view of a carriage included in a hologram apparatus according to an embodiment of the present invention;

FIG. 2 is an exploded perspective view of the carriage shown in FIG. 1;

FIG. 3A is a sectional view of FIG. 1 taken along line IIIA-IIIA, which shows a light-shielded space;

FIG. 3B is an enlarged sectional view of a pinhole filter;

FIG. 4 is a perspective view illustrating the positional relationship between main components included in the hologram apparatus; and

FIG. 5 is a perspective view of the overall structure including the hologram apparatus, illustrating the schematic structure of a carriage-conveying mechanism.

### DESCRIPTION OF THE PREFERRED EMBODIMENTS

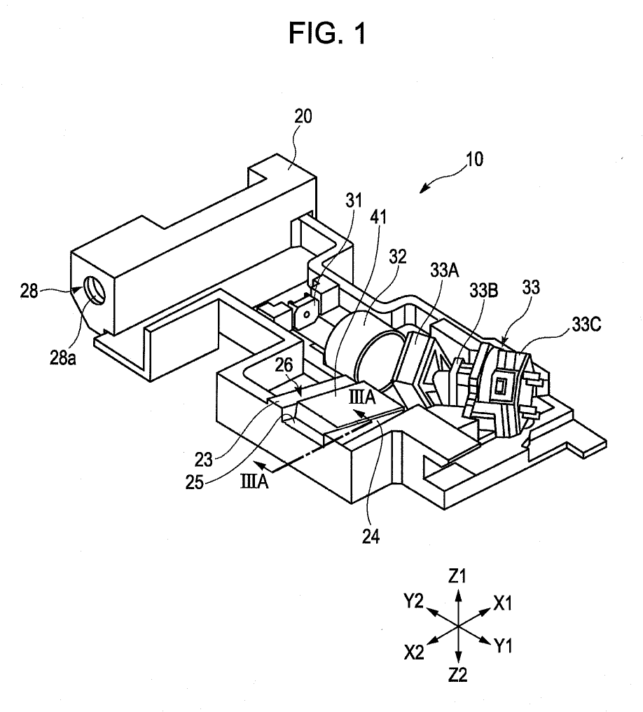

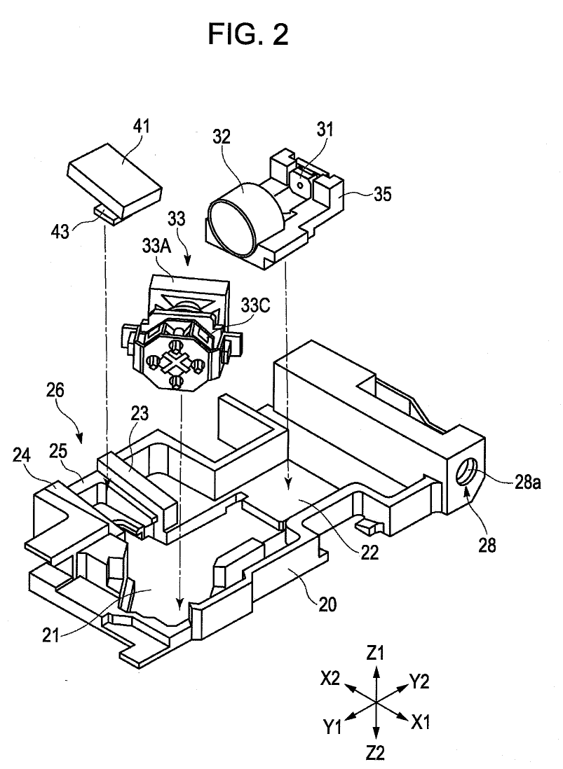

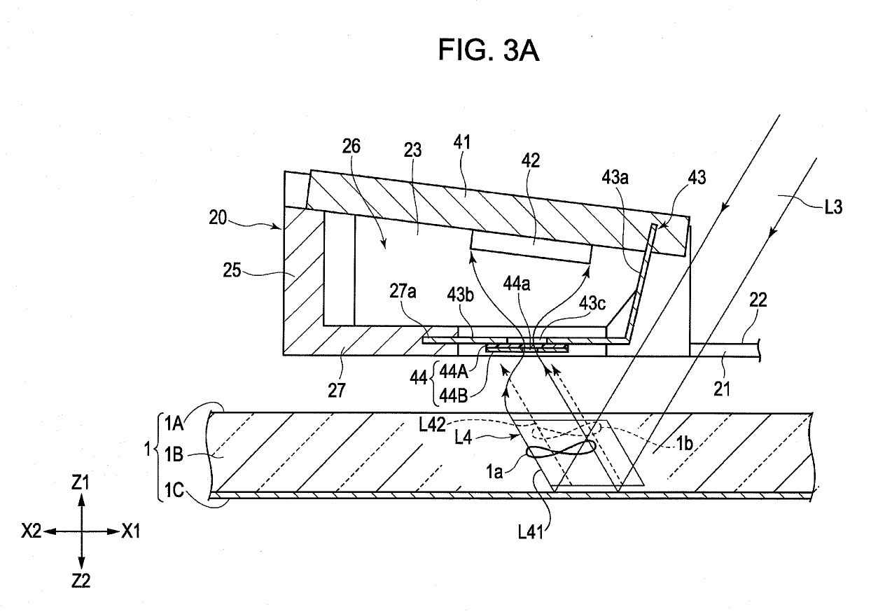

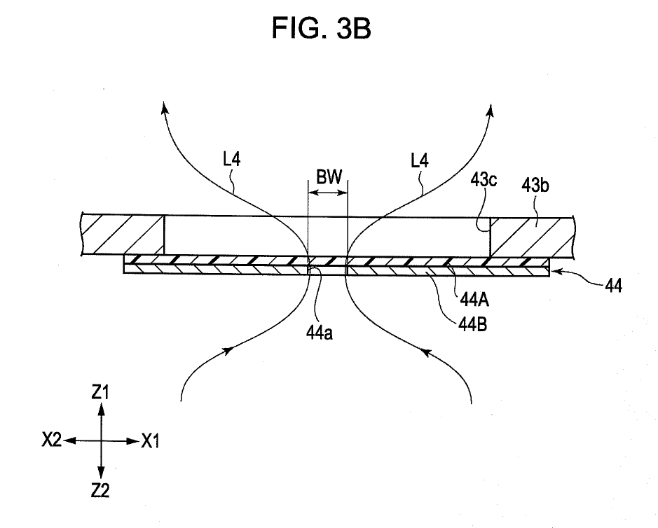

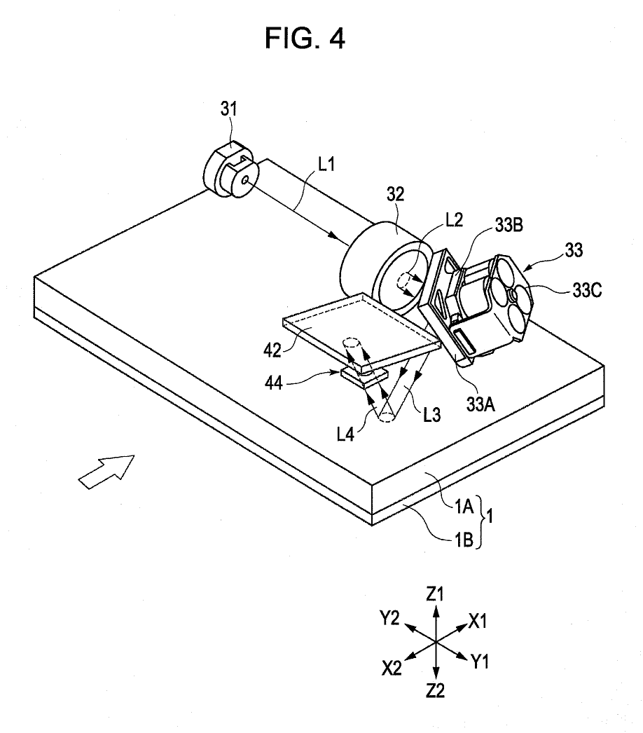

FIG. 1 is a perspective view of a carriage included in a hologram apparatus according to an embodiment of the present invention. FIG. 2 is an exploded perspective view of the carriage shown in FIG. 1. FIG. 3A is a sectional view of FIG. 1 taken along line IIIA-IIIA, which shows a light-shielded space. FIG. 3B is an enlarged sectional view of a pinhole filter. FIG. 4 is a perspective view illustrating the positional relationship between main components included in the hologram apparatus. In FIG. 4, the carriage is not shown.

As shown in FIG. 1, a hologram apparatus (reproducing head) 10 is mounted on a carriage (first carriage) 20. The carriage 20 is supported by a conveying mechanism, which will be described below, such that the carriage 20 is movable along the XY plane in the X direction and the Y direction. As shown in FIG. 3A, a holographic recording medium 1 is placed under the carriage 20 in the Z2 direction. The carriage 20 is capable of moving horizontally along the XY plane while maintaining the state in which the carriage 20 is parallel to the holographic recording medium 1.

Referring to FIGS. 1 and 2, the carriage 20 may be formed of aluminum or the like by die cast molding. A light source 31, a collimating lens 32, a mirror actuator 33, a base 41 to which a photodetector member 42 is fixed, and a light-shielding member 43 are provided on the carriage 20.

The light source 31 includes a laser-emitting unit such as a vertical cavity surface emitting laser (VCSEL). The light source 31 and the collimating lens 32 are mounted on an auxiliary base 35, and are thereby integrated with each other.

As shown in FIGS. 1 and 4, the mirror actuator 33 is placed on a light path of a laser beam emitted from the light source 31. The mirror actuator 33 includes a reflective mirror 33A, a swinging support 33B, and a driving member 33C. The reflective mirror 33A is supported by the swinging support 33B in a swingable manner, and an inclination angle of the reflective mirror 33A can be changed by applying a driving force generated by the driving member 33C to the reflective mirror 33A.

As shown in FIG. 2, the carriage 20 has an opening 21 which extends through the carriage 20 in the Z direction in a central region thereof. A supporting section 22 is provided on the Y2 side of the opening 21 in the figure. The light source 31 and the collimating lens 32, which are integrated with each other, are placed on and fixed to the supporting section 22.

A light-shielded space 26 is provided in the X2 side of the opening 20. As shown in FIG. 3A, the light-shielded space 26 is formed as a space surrounded by the base 41, which defines a top surface of the space, and the light-shielding member 43, which extends from the base 41 and which is substantially L-shaped in cross section.

The base 41 is positioned such that the base 41 is inclined with respect to a horizontal plane (XY plane). Therefore, the photodetector member 42, which is fixed to the bottom surface of the base 41, is also inclined with respect to the horizontal plane (XY plane). An inclination angle of the photodetector member 42 relative to the horizontal plane is determined in accordance with an incident angle at which reference light used for recording holographic information on the holographic recording medium 1 is incident on the holographic recording medium 1. The photodetector member 42 may include, for example, a CCD or a CMOS image sensor.

The light-shielding member 43 includes a base portion 43a which is fixed to the base 41 and a portion 43b which faces a surface of the photodetector member 42 at an end of the light-shielding member 43. A through hole 43c is formed in the portion 43b that faces the photodetector member 42 at a central position thereof, and a pinhole filter 44 is fixed so as to face the through hole 43c. The portion 43b that faces the photodetector member 42 is retained by a retaining member 27a at an end thereof. The retaining member 27a is groove-shaped and is formed in a bottom portion 27 of the carriage 20.

As shown in FIG. 3B, a main member of the pinhole filter 44 may be a thin transparent substrate 44A made of glass, resin, or the like. A metal film 44B made of, for example, chromium may be formed on the surface of the transparent substrate 44A. The metal film 44B may be formed to have a predetermined thickness by a deposition method, such as sputtering and vapor deposition, and may function as a light-blocking film which prevents light from passing therethrough in the film-thickness direction.

In the light-shielded space 26, the through hole 43c formed in the light-shielding member 43 is covered by the transparent substrate 44A. Therefore, dust can be prevented from entering the light-shielded space 26.

The metal film 44B has a pinhole 44a having a predetermined diameter at a central position thereof, and a surface of the transparent substrate 44A is exposed at the pinhole 44a. The pinhole 44a may be formed by the following process. That is, before the metal film 44B is formed, the surface of the transparent substrate 44A is covered with a mask with a predetermined pattern, and a section where the pinhole 44a is to be formed is subjected to a process for preventing the metal film 44B from being formed in that section. Then, the process of forming the metal film 44B is performed. The metal film 44B is formed at least on one of the top and bottom surfaces of the transparent substrate 44A.

The reproduction light output from the holographic recording medium 1 passes through the pinhole 44a and is detected by the photodetector member 42 placed in the light-shielded space 26.

As shown in FIG. 3A, the light-shielding member 43 is positioned at a boundary between a light path of reference light L3 which is incident on the holographic recording medium 1 and a light path of reproduction light L4 which is emitted from the holographic recording medium 1. Therefore, the reference light L3 does not easily enter the light-shielded space 26, and the level of noise component detected by the photodetector member 42 can be reduced.

The entire area of the light-shielded space 26 may be surrounded by wall surfaces. In an example shown in FIG. 3A, the light-shielded space 26 is defined by the base 41, the light-shielding member 43, a pair of inner walls 23 and 24 which face each other in the Y direction at the X2-side end of the opening 21 in the figure, and an outer wall 25 which serves as a portion of the carriage 20 at the X2-side end thereof. Thus, the light-shielded space 26 is surrounded by the wall surfaces of the carriage 20, the light-shielding member 43, and the base 41 at six faces thereof.

Thus, light cannot enter the light-shielded space 26 unless it passes through the pinhole 44a. In other words, the light-shielded space 26 is sectioned from the outside by the light-shielding member 43. In addition, the photodetector member 42 placed in the light-shielded space 26 is separated from the outside so that the photodetector member 42 does not detect light other than the light that reaches the photodetector member 42 through the pinhole 44a.

The six inner surfaces which define the light-shielded space 26, that is, the inner surfaces of the inner walls 23 and 24 and the outer wall 25, the bottom surface of the base 41, and the inner surface of the portion 43b of the light-shielding member 43 that faces the photodetector member 42 may be coated with an antireflection film. In such a structure, the light that enters the light-shielded space 26 through the pinhole 44a can be prevented or suppressed from being reflected by the inner surfaces of the light-shielded space 26. Therefore, the level of noise component detected by the photodetector member 42 can be considerably reduced. As a result, the hologram apparatus can reliably read the holographic information included in the reproduction light L4.

The antireflection film may be formed by, for example, coating the surfaces with a material obtained by dispersing, for example, silica particles in a binder, such as paint. Alternatively, the antireflection film may also be formed by increasing the roughness of the inner surfaces of each member by sandblasting, etching, or the like. Alternatively, the antireflection film may be formed by painting the inner surfaces in black.

The operation of the hologram apparatus 10 will now be described. Referring to FIG. 4, a laser beam L1 emitted from the light source 31 is converted into parallel light L2 having an increased diameter by the collimating lens 32. The thus-obtained light L2 is output to the mirror actuator 33. The driving member 33C included in the mirror actuator 33 is driven so as to adjust the inclination angle of the reflective mirror 33A. In FIG. 4, the reflective mirror 33A is inclined so as to face obliquely downward, and the parallel light L2 reflected by the reflective mirror 33A is incident on the holographic recording medium 1 as the reference light L3.

The holographic recording medium 1 is of a reflective type, and a reflective surface 1C is provided on the bottom surface of an upper recording layer 1B. In the case where, for example, the holographic recording medium 1 is stored in a certain cartridge, the reflective surface 1C may be provided on the bottom surface of the cartridge in which the holographic recording medium 1 is stored.

As shown in FIG. 3A, holograms 1a, 1b, . . . , containing various information are recorded in the recording layer 1B of the holographic recording medium 1 in multiple layers in the form of interference fringes (for example, two-dimensional checkerboard-shaped dot pattern) at different recording angles. Thus, the holographic information in the form of interference fringes is included in the reproduction light L4.

The reference light L3 enters the recording layer 1B through a surface 1A of the holographic recording medium 1, and is reflected by the reflective surface 1C. The thus-reflected reference light L3 interferes with the holograms 1a, 1b, . . . , when the reference light L3 passes through the recording layer 1B, and the reproduction light L4 is generated accordingly. The reproduction light L4 is emitted from the holographic recording medium 1 through the surface 1A.

The reproduction light L4 is in the form of convergent light due to phase conjugation, and a portion where the beam diameter is at a minimum is referred to as a beam waist BW (see FIG. 3B). The pinhole filter 44 is positioned such that the pinhole 44a is at a position corresponding to the beam waist BW of the reproduction light L4.

For example, when the reference light L3 is incident on the hologram 1a recorded in the holographic recording medium 1, reproduction light L41 shown by the solid lines is generated. At the same time, reproduction light L42 shown by the dashed lines is generated by the hologram 1b, which partially overlaps the hologram 1a. When the beam waist BW of the reproduction light L41 from the hologram 1a coincides with the pinhole 44a so that the reproduction light L41 can pass through the pinhole 44a, the beam waist BW of the reproduction light L42 from the hologram 1b does not coincide with the pinhole 44a and the reproduction light L42 cannot pass through the pinhole 44a. Similarly, when the beam waist BW of the reproduction light L42 from the hologram 1b coincides with the pinhole 44a so that the reproduction light L42 can pass through the pinhole 44a, the beam waist BW of the reproduction light L41 from the hologram 1a does not coincide with the pinhole 44a and the reproduction light L41 cannot pass through the pinhole 44a. Thus, the pinhole filter 44 allows only the reproduction light L4 whose beam waist BW is at the position of the pinhole 44a to pass therethrough, and blocks the other reproduction light L4. Therefore, in this hologram apparatus, even if a plurality of beams of reproduction light L4 are generated at the same time, only the necessary reproduction light L4 is selectively allowed to pass through the pinhole filter 44. As a result, the holographic information of only the reproduction light L4 that passes through the pinhole filter 44 is detected by the photodetector member 42.

The conveying mechanism for conveying the carriage 20 on which the above-described hologram apparatus is mounted in the X and Y directions will now be described.

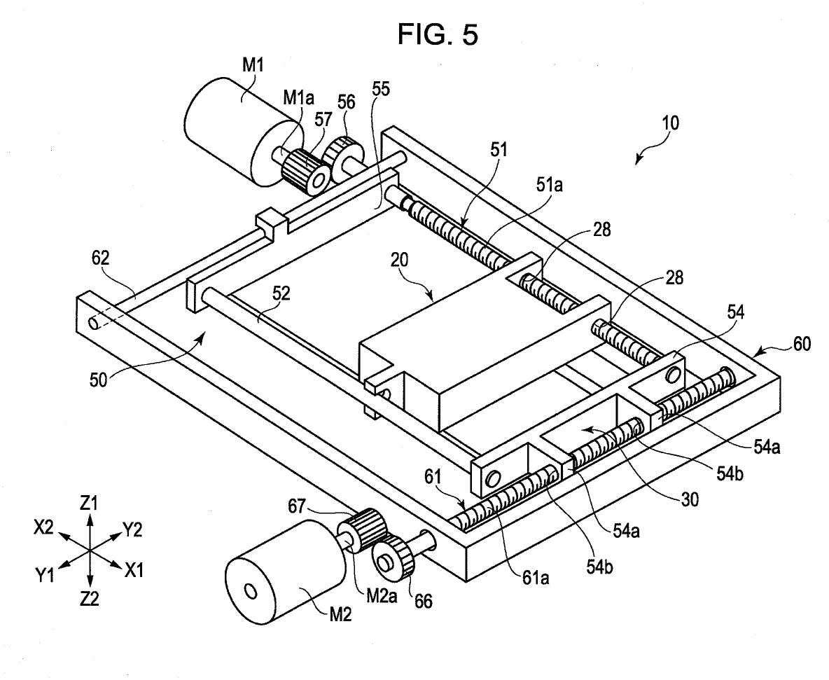

FIG. 5 is a perspective view of the overall structure including the hologram apparatus, illustrating the schematic structure of a carriage-conveying mechanism.

As shown in FIGS. 1 and 5, the carriage 20 has through holes 28 which extend through the carriage 20 in the X direction at the Y2-side end thereof in the figures. Internal thread 28a are formed in the inner surfaces of the through holes 28. A first screw shaft 51 having a helical feeding thread 51a is inserted through the through holes 28. The feeding thread 51a meshes with the internal thread 28a.

A guide shaft 52 is disposed at the Y1 side in FIG. 5 such that the guide shaft 52 extends parallel to the first screw shaft 51 with a predetermined distance therebetween. The carriage 20 is supported by the guide shaft 52 at the Y1-side end thereof such that the carriage 20 can slide in the X direction in the figure. Side frame members 54 and 55 are provided at either ends of the first screw shaft 51 and the guide shaft 52. Both ends of each of the first screw shaft 51 and the guide shaft 52 are disposed between the side frame members 54 and 55.

The first screw shaft 51, the guide shaft 52, and the side frame members 54 and 55 form a second carriage 50. The first screw shaft 51 is supported such that the first screw shaft 51 is rotatable relative to the side frame members 54 and 55.

A reduction gear 56 is fixed to the first screw shaft 51 at an end thereof such that the reduction gear 56 meshes with a gear 57 fixed to a rotating shaft M1a of an external driving motor M1. When electric power is supplied to the driving motor M1 and the first screw shaft 51 is rotated, the carriage 20 moves along the X direction in accordance with the rotating direction of the first screw shaft 51.

A pair of supporting pieces 54a and 54a are formed on the side frame member 54 at the X1 side, and through holes 54b and 54b are formed in the supporting pieces 54a and 54a so as to extend through the supporting pieces 54a and 54a in the Y direction. Internal threads are formed in the inner surfaces of the through holes 54b and 54b.

A support frame 60 is disposed so as to surround the second carriage 50. In the present embodiment, the support frame 60 is angular U-shaped in a plan view. A second screw shaft 61 which extends in the Y direction is rotatably supported by the support frame 60 at the X1-side end thereof. The second screw shaft 61 extends through the through holes 54b and 54b. The second screw shaft 61 has a feeding thread 61a formed in the surface thereof, and the feeding thread 61a meshes with the internal threads formed in the inner surfaces of the through holes 54b and 54b.

A guide shaft 62 is disposed at the X2-side end of the support frame 60 such that the guide shaft 62 extends parallel to the second screw shaft 61. The side frame member 55 of the second carriage 50 is supported such that the side frame member 55 is movable in the Y direction in the figure with respect to the guide shaft 62.

A reduction gear 66 is fixed to the second screw shaft 61 at an end thereof such that the reduction gear 66 meshes with a gear 67 fixed to a rotating shaft M2a of an external driving motor M2. When electric power is supplied to the driving motor M2 and the second screw shaft 61 is rotated, the second carriage 50 moves along the Y direction in accordance with the rotating direction of second screw shaft 61.

Thus, according to the present invention, the second carriage 50 can be moved in the Y direction, and the carriage (first carriage) 20 can be moved in the X direction. Therefore, the carriage 20 can be moved along the XY plane while the carriage 20 faces the holographic recording medium 1.

According to the above-described embodiment, the entire periphery of the light-shielded space 26 in which the photodetector member 42 is placed is surrounded by wall surfaces forming the carriage 20. However, the present invention is not limited to this, and the photodetector member 42 may be disposed in, for example, a box having a pinhole.

In the above-described embodiment, the carriage 20 is movable in two directions, which are the X direction and the Y direction. However, the present invention is not limited to this, and the structure may also be such that the carriage is reciprocated in only one of the X direction and the Y direction.

What is claimed is:

1. A hologram apparatus, comprising:
a carriage arranged to face an optical recording medium;
a light source mounted on the carriage and configured to emit reference light for reproducing information from the optical recording medium; and
a photodetector member mounted on the carriage and configured to detect reproduction light emitted from the optical recording medium in response to receiving the reference light,
wherein the carriage has a light-shielded space which surrounds the photodetector member, the light-shielded space being surrounded by a plurality of wall surfaces of the carriage and a light-shielding member positioned between the optical recording medium and the photodetector member, and
wherein the light-shielding member includes a pinhole filter positioned at a boundary between a light path of the reference light and a light path of the reproduction light, the pinhole filter allowing only the reproduction light to pass therethrough and guiding the reproduction light toward the photodetector member.

2. The hologram apparatus according to claim 1, wherein the pinhole filter includes a transparent substrate, a light-blocking film formed on at least one surface of the transparent substrate, and a pinhole formed by partially leaving an area where the light-blocking film is not formed on the transparent substrate so that the transparent substrate is partially exposed at the pinhole.

3. The hologram apparatus according to claim 2, wherein the light-blocking film includes a metal film.

4. The hologram apparatus according to claim 1, wherein the pinhole is formed at a position corresponding to a beam waist position at which a beam diameter of the reproduction light is at a minimum.

5. The hologram apparatus according to claim 1, wherein an antireflection film is formed on one or both of the light-shielding member and the wall surfaces.
